(19) United States
(12) Patent Application Publication
(10) Pub. No.: US 2023/0076842 A1
(43) Pub. Date: Mar. 9, 2023

(54) SYSTEMS & METHODS FOR ACTIVELY MONITORING LATENCY IN A NETWORK FABRIC

(71) Applicant: Flipkart Internet Private Limited, Bengaluru (IN)

(72) Inventors: Raghdipsingh Raghbirsingh PANESAR, Bangalore (IN); Vikas VERMA, Nagercoil (IN); Vishwas TIWARI, Bengaluru (IN)

(73) Assignee: Flipkart Internet Private Limited, Bengaluru (IN)

(21) Appl. No.: 17/899,225

(22) Filed: Aug. 30, 2022

(30) Foreign Application Priority Data
Aug. 31, 2021 (IN) 202141039389

(51) Int. Cl. H04L 45/24; H04L 45/00; H04L 43/0864

(52) U.S. Cl. CPC H04L 45/24; H04L 45/566; H04L 43/0864

(57) ABSTRACT

The present disclosure relates to methods and systems for actively monitoring a latency in a network fabric comprising one or more data centres. The method begins with identifying a path between a pinger node and a responder node. A custom packet is then generated to be routed from the pinger node to the responder node via the path. Thereafter, the custom packet is encapsulated with one or more IP headers and deterministically routed from the pinger node to the responder node, subsequent to which a reverse custom packet is generated to be routed from the responder node to the pinger node. Next, the reverse custom packet is encapsulated with one or more IP headers. The method then includes deterministically routing the encapsulated reverse custom packet from the responder node to the pinger node and monitoring the latency between the pinger node and the responder node.

### FIELD OF THE DISCLOSURE

The present disclosure generally relates to the field of networking and more particularly, to methods and systems for actively monitoring latency in a network fabric.

### BACKGROUND OF THE DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Data centres are centralized structures where a large group of networked computer servers are located, and used for remote storage, processing or distribution of large amounts of data. Monitoring of efficient working of servers and other network equipment in a data centre are paramount to successful working of the data center. Nowadays, almost all productivity applications, cloud based services, etc. are dependent on data centers, and thus, user's everyday life is largely impacted by the non-working or inefficient working of a data centre. It is thus extremely important that the network in data centres is up and running at all times at optimum efficiency rates.

Typically, when there is a network failure in a data centre, a human-driven investigation is initiated that takes a large amount of time to find faults and to correct them. Some of the faults/issues can be detected using traditional network monitoring, by probing devices using Simple Network Management Protocol (SNMP), device logs or using Command Line Interface (CLI). These existing techniques of network monitoring in a data centre are time consuming. The data gathering itself takes so much time that the remediation response to be taken to correct the faults is very high.

Further, a data centre may include many elements or components that are not capable of reporting its own malfunctioning. Similarly, there may be situations when the components in a data center may not report malfunctioning, however, decreased efficiency of such elements may be experienced. Such failures are known as grey failures. For such failures, there is a need to build a system that provides latency between two components of a data centre at all times to be able to proactively generate alerts in the data centre in case of any malfunctioning or faults.

One of the existing solutions of latency management includes running a probing agent between two components (say, a source component and a destination component) in a data centre to identify the latency between these two components. In such a solution, a dummy agent generates thousands of probing packets that are sent from the source to the destination component. Between any two components of a data centre, there are typically many different paths through which a data packet may travel. Which path is chosen for which data packet, is controlled by the various elements between the source and destination components, based on the current traffic on such paths. The existing solution sends thousands of packets between the source and destination, and thereafter, an average latency for these thousands of packets sent from the source to the destination, is calculated. This solution is ineffective because thousands of probes are required to be run from the source to the destination to ensure that the packets are sent via every path possible between the source and the destination. This results in wastage of a lot of resources. Another drawback of this solution is that it provides only an average latency between the source and the destination, and is not able to provide the cause of such latency, i.e. it is unable to identify which component/s of the network are causing such latency. Furthermore, there is unpredictability in terms of how many paths have been covered or if all the paths between the source and destination have been covered by the probing agents.

In another existing solution, a small number of probing agents are placed in a cluster within a bigger network of the data centre. These probing agents send User Datagram Protocol (UDP) probe packets to all devices within the cluster and measure the latency. While use of UDP over TCP makes the process more efficient as UDP is less resource intensive as compared to TCP, this solution is still disadvantageous as a large number of probes are still required to be sent to cover all paths between the source and destination. This solution also has the same limitations as the previous solution, i.e., it is not able to identify which component/s of the network are causing latency, and there is unpredictability in terms of how many paths have been covered or if all the paths between the source and destination have been covered by the probing agents.

In view of these existing limitation in the state of the art, there exists an imperative need to provide systems and methods for actively and more efficiently monitoring latency in a network.

### SUMMARY OF THE DISCLOSURE

This section is provided to introduce certain aspects of the present disclosure in a simplified form that are further described below in the detailed description. This summary is not intended to identify the key features or the scope of the claimed subject matter.

An object of the present disclosure is to provide systems and methods for actively monitoring latency in a network fabric, that overcomes the limitations and drawbacks of the state of the art solutions. Another objective of the present disclosure is to provide systems and methods for monitoring latency that are able to identify faulty devices in the network fabric that are causing such latency. Yet another object of the disclosure is to provide systems and methods for monitoring latency that are able to monitor latency between every two components in the network fabric of the whole data center or even multiple data centers. Another object of the present disclosure is to provide systems and methods for monitoring latency that are resource efficient. Yet another objective of the present disclosure is to provide systems and methods for monitoring latency that are able to overcome the unpredictability existing in the prior known solutions, i.e., unpredictability of the number of paths covered by a probing agent while monitoring latency in a network. Another objective of the present disclosure is to provide systems and methods that are capable of measuring the latency between hops in a network fabric as accurately as possible and in turn detect anomalies like silent packet drops, increased latency or throttling in the underlying fabric correctly.

In order to achieve these and other objectives, an aspect of the disclosure relates to a method for actively monitoring a latency in a network fabric comprising one or more data centres. The method begins with identifying, by an identification unit, a path between a pinger node and a responder node, wherein the pinger node and the responder node are located in the one or more data centres across the network fabric, and the path comprises a set of nodes. A custom packet is then generated by a packet generator, to be routed from the pinger node to the responder node via the path. Thereafter the custom packet for the path is encapsulated with one or more IP headers based on the set of nodes. The method then includes deterministically routing, by a processing unit, the encapsulated custom packet from the pinger node to the responder node via the path, subsequent to which a reverse custom packet is generated by the packet generator to be routed from the responder node to the pinger node via the path. Next, the reverse custom packet for the path is encapsulated with one or more IP headers based on the set of nodes. The method then includes deterministically routing, by the processing unit, the encapsulated reverse custom packet from the responder node to the pinger node via the path; and monitoring, by a monitoring unit, the latency between the pinger node and the responder node based at least on the deterministically routing of the encapsulated custom packet from the pinger node to the responder node via the path and deterministically routing the encapsulated reverse custom packet from the responder node to the pinger node via the path.

Another aspect of the disclosure relates to a system for actively monitoring a latency in a network fabric comprising one or more data centres, the system comprising: an identification unit, a packet generator, a processing unit and a monitoring unit, all components connected to each other. The identification unit configured is to identify a path between a pinger node and a responder node, wherein the pinger node and the responder node are located in the one or more data centres across the network fabric, and the path comprises a set of nodes. The packet generator is configured to generate a custom packet to be routed from the pinger node to the responder node via the path, and encapsulate the custom packet for the path with one or more IP headers based on the set of nodes. The processing unit is configured to deterministically route the encapsulated custom packet from the pinger node to the responder node via the path. The packet generator is further configured to generate a reverse custom packet to be routed from the responder node to the pinger node via the path, and encapsulate the reverse custom packet for the path with one or more IP headers based on the set of nodes. Further, the processing unit is further configured to deterministically route the encapsulated reverse custom packet from the responder node to the pinger node via the path. The monitoring unit is configured to monitor the latency between the pinger node and the responder node based at least on the deterministic routing of the encapsulated custom packet from the pinger node to the responder node via the path and deterministic routing the encapsulated reverse custom packet from the responder node to the pinger node via the path.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure.

FIG. 1A illustrates an exemplary network fabric across one or more data centres.

FIG. 1B shows a typical Clos network topology.

FIG. 2 illustrates a set of paths between two nodes in the network fabric.

FIG. 3 illustrates a system for actively monitoring a latency in a network fabric comprising one or more data centres, in accordance with exemplary embodiments of the present disclosure.

FIG. 4 illustrates a method for actively monitoring a latency in a network fabric comprising one or more data centres, in accordance with exemplary embodiments of the present disclosure.

FIG. 5A illustrates a signal flow diagram between a client and a server in the network fabric via a TCP/IP protocol, as known in the art.

FIG. 5B shows a signal flow diagram between a pinger and a responder node in accordance with exemplary embodiments of the present invention.

FIG. 6 illustrates an exemplary encapsulated custom packet generated in accordance with exemplary embodiments of the present disclosure.

FIG. 7 illustrates an exemplary method of deterministically routing the encapsulated custom packet from the pinger node to the responder node, in accordance with exemplary embodiments of the present disclosure.

FIG. 8 illustrates an exemplary method of deterministically routing the encapsulated reverse custom packet from the responder node to the pinger node, in accordance with exemplary embodiments of the present disclosure.

The foregoing shall be more apparent from the following more detailed description of the embodiments of the disclosure.

### DETAILED DESCRIPTION

In the following description, for the purposes of explanation, various specific details are set forth to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section, the existing solutions for monitoring latency between components in a network of a data centre are unable to determine deterministically the cause of the latency. The existing solutions are unable to identify which component/s of the network are causing latency, and there is unpredictability in terms of how many paths have been covered or if all the paths between the source and destination have been covered by the probing agents.

Instead of depending upon a reactive approach based on traditional monitoring systems, the present disclosure proposes methods and systems for actively monitoring latency between nodes in a network fabric. The disclosure proposes sending continuous probes between nodes in a network fabric wherein the probes are deterministically routed to cover all network paths between the nodes. Latency is then calculated between end nodes and the latency data is analysed to identify faults or generate alerts when decreased efficiency is experienced. A more detailed explanation of the solution proposed by the present disclosure is provided below in reference to various diagrams.

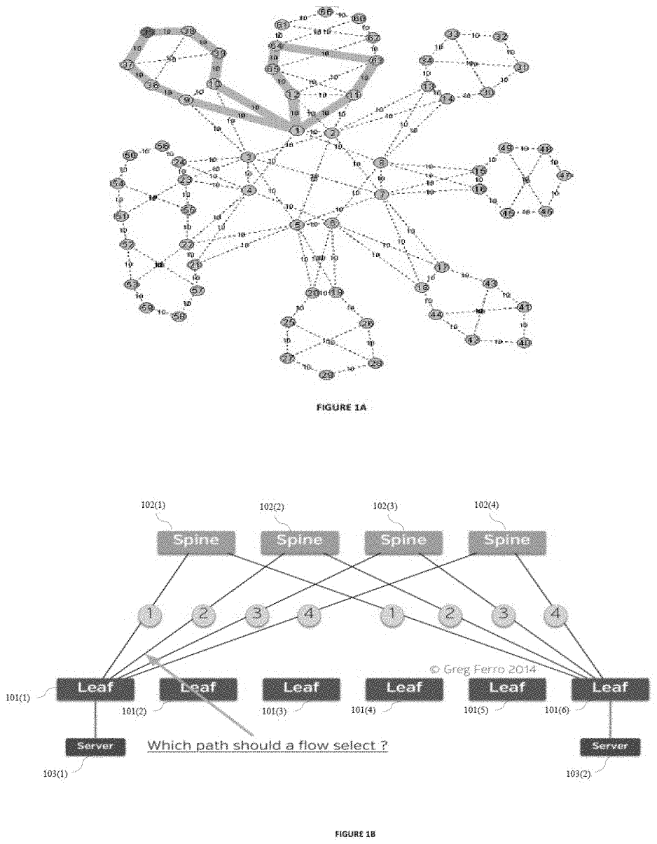

FIG. 1A illustrates an exemplary network fabric across one or more data centres. Modern large scale data centres comprise of hundreds or thousands of servers connected to each other via communication equipment such as routers and switches via wired or wireless connections. A ‘network fabric’ is a network of servers wherein each component, i.e., servers as well as switches, is connected (either directly or indirectly) to every other component in the network. The dotted lines in FIG. 1 show a wired or wireless connection between various components or nodes in the network fabric. This network fabric may comprise or may be spread across one or more data centres. Network fabric across one or more data centres typically use Clos topology or architecture. Clos is a type of non-blocking, multistage switching architecture that uses Equal Cost multi-path routing protocol.

FIG. 1B shows a typical Clos network topology. As shown, the Clos topology network comprises a first layer of switches called leaves [101(1), 101(2), 101(3), 101(4), collectively 101] and a second layer of switches called spine [102(1), 102(2), 102(3), 102(4), collectively 102]. In the Clos topology network, every leaf [101] is connected to every spine [102] and vice versa. As shown, leaf 101(1) is connected to spine 102(1), spine 102(2), spine 102(3) and spine 102(4).

The servers [103(1), 103(2), collectively 103] of the network fabric are attached to the leaves [101]. One or more servers may be attached to every leaf and in an implementation as many as 30-40 servers may be attached to one leaf. A server [103(1)] may be singly attached, i.e., the server [103(1)] may be connected to only one leaf [101(1)]. A server [103(2)] may also be dual attached, i.e. server [103(2)] may be connected to a pair of leaves [101(3) and 101(4)]. In this network topology, the failure domain is constrained to where the fault occurs. For instance, if a leaf 101(1) is faulty or not working, the affected portion of the network is the servers connected to the leaf [101(1)]. Similarly, if one spine [102(1)] is faulty or is not working, then there are other spines such as [102(2)], [102(3)] and [102(4)] through which packets can be routed.

The routing strategy used by Clos network is the Equal-cost multi-path routing. As shown in FIG. 1A, every connection between two nodes or components of the network fabric, is assigned a cost or weight of 10. The ECMP allows forwarding of packets from a source node to a destination node via multiple paths with equal routing priority. The traffic between the source and destination nodes over multiple paths is balanced via load-balancing techniques. For instance, load balancing may be done on HASH of traffic. Alternatively, other load balancing techniques such as IP Modulo, Round Robin, Weighted Round Robin, etc. may be used.

Although a limited number of spines, leaves and servers are shown in FIGS. 1A and 1B, it will be appreciated by those skilled in the art that the disclosure is not limited to any number of such components or the architecture depicted in FIGS. 1A and 1B.

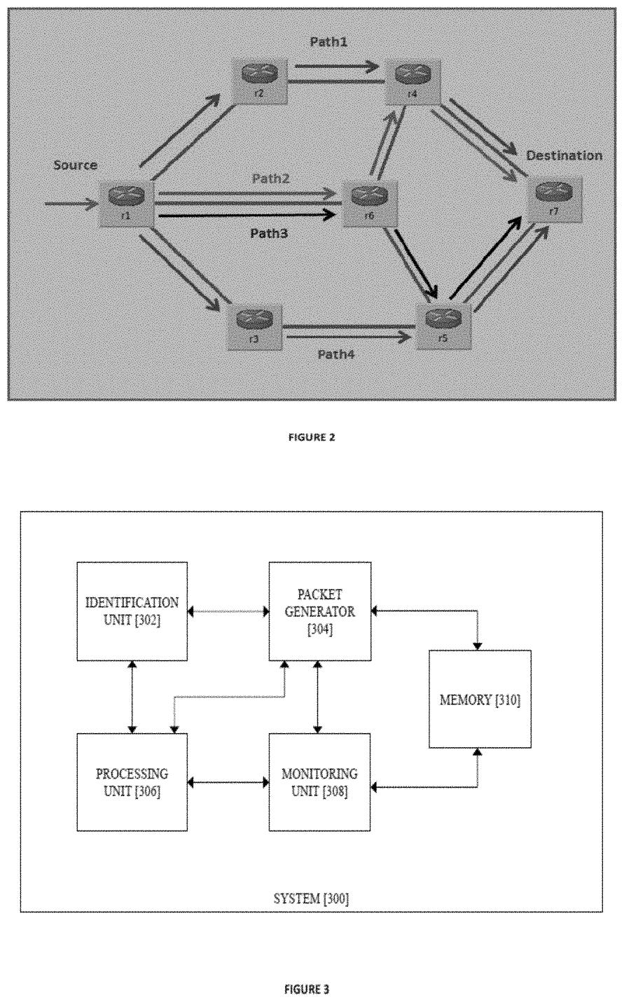

FIG. 2 illustrates a set of paths between two nodes in the network fabric. FIG. 2 shows a small portion of the network fabric. As used herein, a ‘path’ is a route followed by a data packet while traveling from one node to another in a network fabric. Consider an example that a packet is to be routed from node r1 to r7. In this example, the following set of paths are possible:

| S. No. | Path |
|---|---|
| Path_1 | r1 r2 r4 r7 |
| Path_2 | r1 r6 r4 r7 |
| Path_3 | r1 r6 r5 r7 |
| Path_4 | r1 r3 r5 r7 |

If the above-mentioned ECMP routing strategy is used, the path from the above-mentioned set of paths that will be followed by any packet will be decided based on the load balancing strategy. If any of the nodes or communication links between the nodes fail, or have decreased efficiency, the time taken by the packet to reach the destination via a path comprising such faulty node, will be higher than usual. For instance, if r6 is affected, then latency for Path_2 and Path_3 will increase. It is important to identify the existence of increased latency and the path in which such latency is increased.

In the prior known solutions, as discussed in the background section, if an increased latency is reported, the prior known latency monitoring systems deploy probing agents that send thousands of packets from the source to the destination (r1 to r7 in this case). Since in Clos topology following ECMP routing strategy it was not possible to know which packet is following which path, the exact cause of the latency could not be found. For instance, in the above example, if latency is reported between r1 and r7, the prior known systems would send thousands of packets from r1 to r7 and then calculate an average latency of all those packets. These thousands of packets are sent from r1 to r7 so that the packets are automatically routed via all or almost all paths between r1 and r7. However, it is not possible to determine which packet followed which of the paths from Path_1, Path2, Path_3 and Path_4. It is also not possible to positively ascertain if packets were sent via all paths, i.e. Path_1, Path2, Path_3 and Path_4. Thus, resources for running thousands of packets are wasted and the latency calculated is still a probabilistic determination of the latency between the two nodes.

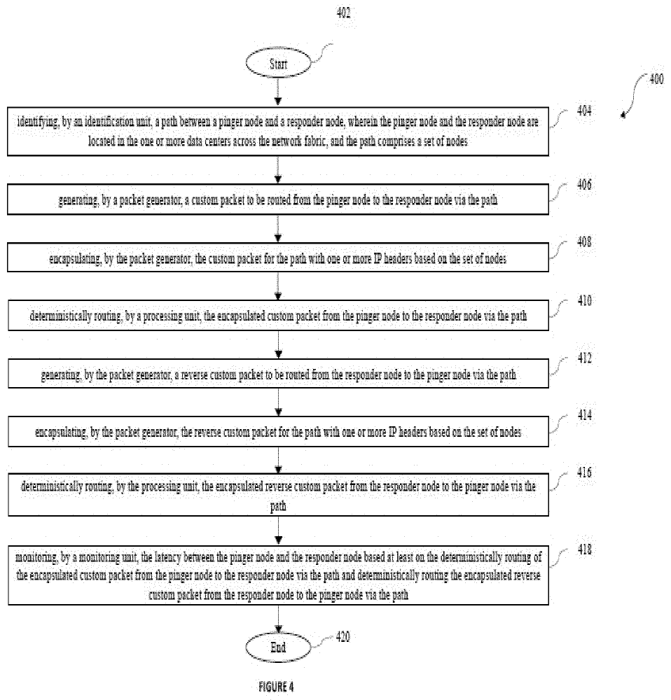

The present disclosure proposes a solution whereby packets are deterministically routed via each path, i.e. Path_1, Path2, Path_3 and Path_4, between the source and the destination. A latency for each path is then calculated. This allows to ensure that all paths between the source and the destination are tested. Further, since the latency for each path is calculated, it is possible to know the specific path where a fault has occurred or efficiency has decreased. A more detailed explanation of the solution is now provided below with reference to FIGS. 3-8.

FIG. 3 illustrates a system for actively monitoring a latency in a network fabric comprising one or more data centres, in accordance with exemplary embodiments of the present disclosure. As shown in FIG. 3, the system [300] for actively monitoring a latency in a network fabric comprising one or more data centres, comprises at least one identification unit [302], at least one packet generator [304], at least one processing unit [306], at least one monitoring unit [308] and at least one memory [310], all components connected to each other unless otherwise indicated below. Although only one identification unit [302], one packet generator [304], one processing unit [306], one monitoring unit [308] and one memory [310] is shown in FIG. 3, it will be appreciated by those skilled in the art that any number of such units are encompassed by the embodiments of the present disclosure. The system [300] through the interconnection of various components actively monitors latency in a network fabric. The present disclosure proposes to actively monitor the latency between every two nodes in the network fabric. For the ease of explanation, the system described herein describes calculation of latency between two nodes, i.e. a source node or a pinger node and a destination node or a responder node. It will be appreciated by those skilled in the art that the system monitors latency between every two nodes in the network fabric in the same manner as described for the pinger node and the responder node.

The identification unit [302] is configured to identify a path between the pinger node and the responder node. As discussed above, the pinger node and the responder node are located in the one or more data centres across the network fabric. The path between the pinger node and the responder node comprises a set of nodes. The set of nodes in each path refers to the nodes through which the packet will be routed from the pinger node to the responder node. The disclosure encompasses that the identification unit [302] identifies each possible path between the pinger node and the responder node. For instance, referring to FIG. 2 again, r1 is the pinger node and r7 is the responder node. The identification unit [302] in this example, identifies the following paths between the pinger node r1 and the responder node r7. The set of nodes in Path_1 are r1, r2, r4 and r7; and similarly the set of nodes in Path_3 are r1, r6, r5 and r7.

| S. No. | Path |
|---|---|
| Path_1 | r1 r2 r4 r7 |
| Path_2 | r1 r6 r4 r7 |
| Path_3 | r1 r6 r5 r7 |
| Path_4 | r1 r3 r5 r7 |

The identification unit [302] is configured to provide the identified one or more paths to the packet generator [304] and the memory [310].

The packet generator [304] is a hardware unit. This packet generator [304] is configured to generate a custom packet to be routed from the pinger node to the responder node via the path. In an event multiple paths are identified, the packet generator [304] is configured to generate a custom packet for each of such paths. The packet generator [304] is further configured to encapsulate the custom packet for the path with one or more IP headers based on the set of nodes in said path. To encapsulate the custom packet, the packet generator [304] identifies an IP address of each node in the set of nodes in the path. Further, the packet generator [304] generates the one or more IP headers based on the IP address of each node in the set of nodes. The packet generator [304] is configured to provide the encapsulated packet to the processing unit [306].

The packet generator [304] is further configured to embed a signature of the path in the custom packet to be routed from the pinger node to the responder node.

The processing unit [306] is configured to receive the encapsulated custom packet from the packet generator [304] and deterministically route the encapsulated custom packet from the pinger node to the responder node via the path. To deterministically route the encapsulated custom packet, the processing unit [306] is configured to decapsulate an outermost IP header of the custom packet at each node of the set of nodes; and identify a next node in the path to route the custom packet to the responder node, based on the decapsulation. Further, the processing unit [306] is also configured to route the custom packet to the identified next node.

Once the encapsulated custom packet reaches the responder node, the packet generator [304] is further configured to generate a reverse custom packet to be routed from the responder node to the pinger node via the path, and encapsulate the reverse custom packet for the path with one or more IP headers based on the set of nodes. The reverse custom packet to be routed from the responder node to the pinger node via the path is generated based on the embedded signature in the packet.

The processing unit [306] is further configured to deterministically route the encapsulated reverse custom packet from the responder node to the pinger node via the path. To deterministically route the encapsulated reverse custom packet, the processing unit [306] is configured to decapsulate an outermost IP header of the custom packet at each node of the set of nodes. The processing unit [306] is also configured to identify a next node in the path to route the custom packet to the pinger node, based on the decapsulation; and route the custom packet to the identified next node.

The monitoring unit [308] is configured to monitor the latency between the pinger node and the responder node based at least on the deterministic routing of the encapsulated custom packet from the pinger node to the responder node via the path and deterministic routing the encapsulated reverse custom packet from the responder node to the pinger node via the path.

The monitoring unit [308] is further configured to calculate a round trip time for the path based on a time taken for deterministically routing of the encapsulated custom packet from the pinger node to the responder node via the path and deterministically routing the encapsulated reverse custom packet from the responder node to the pinger node via the path. As used herein, a ‘round trip time’ refers to the time duration taken by a packet to travel from the pinger node to the responder node and back to the pinger node. An increased round trip time of the packet is indicative of increased latency in the network.

The monitoring unit [308] is also configured to detect an anomaly in the path based on the calculated round trip time for the path and a historical round trip time data for the path.

The memory [310] is configured to store the data and information generated by the other components of the system [300]. The memory [310] is configured to store the paths identified by the identification unit [302], the IP addresses of all the nodes in the network fabric, the custom packets generated by the packet generator [304], the latency derived by the monitoring unit [308], the anomalies detected by the monitoring unit [308], etc. Some or all of this data may be stored either permanently or temporarily.

FIG. 4 illustrates a method for actively monitoring a latency in a network fabric comprising one or more data centres, in accordance with exemplary embodiments of the present disclosure. The method begins at step 402. The disclosure encompasses that the method 400 is a continuous active monitoring process. Thus, there is no trigger for the process 400 to begin.

At step 404, the method includes identifying, by an identification unit [302], a path between a pinger node and a responder node, wherein the pinger node and the responder node are located in the one or more data centers across the network fabric, and the path comprises a set of nodes. In case multiple paths exist between the pinger and the responder node, the step 404 encompasses identifying each of such paths. Referring again to FIG. 2 for an example, the source node r1 is the pinger node and the destination node r7 is the responder node. Step 404 includes identifying the following paths between the pinger node and the responder node:

| S. No. | Path |
|---|---|
| Path_1 | r1 r2 r4 r7 |
| Path_2 | r1 r6 r4 r7 |
| Path_3 | r1 r6 r5 r7 |
| Path_4 | r1 r3 r5 r7 |

As shown above, each path or route comprises a set of nodes. For instance, Path_1 includes a set of nodes: r1, r2, r4 and r7; similarly Path_4 includes a set of nodes: r1, r3, r5 and r7. The disclosure encompasses that the paths identified between the pinger node and the responder node are stored in the memory [310] of the system [300]. This table comprising the paths is updated at periodic intervals or in an event there is a change in the network configuration. The disclosure also encompasses that the paths between each pair of nodes in the network fabric are identified and stored in the memory [310].

Next, step 406 includes generating, by the packet generator [304], a custom packet to be routed from the pinger node to the responder node via the path. Generation of the custom packet includes embedding, by the packet generator [304], a signature of the path in the custom packet to be routed from the pinger node to the responder node. A custom packet is a customized Synchronize (SYN) packet that allows to measure latency more accurately. The payload of the custom SYN packet comprises intermittent hop details, i.e., the list of nodes in the path through which the packet is routed. For instance, in the above example, when the packet is routed through Path_1, the SYN packet comprises the details of intermittent hops r1, r2, r4 and r7. This information is provided in the reverse order and is called a signature of the path or reverse IP-IP signature. For instance, the reverse signature of Path_1 may be “r7 r4 r2 r1”. The disclosure encompasses that when multiple paths are identified in step 404, then multiple custom packets for each path are generated at step 406.

Referring now to FIGS. 5A and 5B that shows the difference between a known in the art TCP/IP packet and the custom packet of the present invention. FIG. 5A illustrates a signal flow diagram between a client and a server in the network fabric via a TCP/IP protocol, as known in the art; while FIG. 5B shows a signal flow diagram between a pinger and a responder node in accordance with exemplary embodiments of the present invention.

As shown in FIG. 5A, the signal flow between a client and a server is as follows: When a probe packet is required to be sent from one node to another in the network fabric, a TCP connection is first required to be established between the two nodes. To establish the connection, firstly, the client sends a synchronize packet (SYN) to the server. Thereafter, the server sends back a Synchronize-Acknowledgement packet (SYN-ACK) to the client. The client then sends an acknowledgement message to the server. This exchange establishes the connection between the client and the server. Once the connection is established, a probing request packet is sent from the client to the server and the probing response packet is received at the client from the server. The round trip time for the probing packet between two nodes as measured by the prior known solutions thus, is the sum of the connection time and the actual request and response time. Since multiple round trips are required between the client and the server in this process, it does not represent the true round trip time latency. This is because the latency could have occurred in this connection establishment procedure due to a network issue, and there may be no latency in the actual request and response. However, since round trip time involves a sum of the connection time and the actual request and response time, any latency in such measured round trip time may not be accurate in this scenario where there was no latency in the actual request and response.

To overcome these issues, the present disclosure proposes to generate and use custom packets. As shown in FIG. 5B, the pinger node sends a custom syn packet generated by the system [300] to the responder node and receives back the custom syn-ack packet. Since no connection establishment is required, actual round trip time can be determined using the custom packets. All the sockets used by pinger and responder nodes are RAW sockets, the proposed solution never creates an actual TCP connection or does a TCP handshake as both pinger and responder are not listening on a port but instead use a BPF filter to capture the incoming packet of interest.

The disclosure encompasses that all the custom packets created by the proposed method are SYN/SYN-ACK packets, and these packets never reach any program running in user-space and are fully handled by the kernel. To enable a user space program to capture these packets, the pinger and responder in user space open up a TCP-RAW socket, bind it to the machine main interface and then attach a BPF filter to filter only the intended packets. At the receiver side the BPF filter is used to capture the custom SYN packets (request) and similarly at the pinger side the BPF filter is used to capture the custom SYN-ACK packet (response).

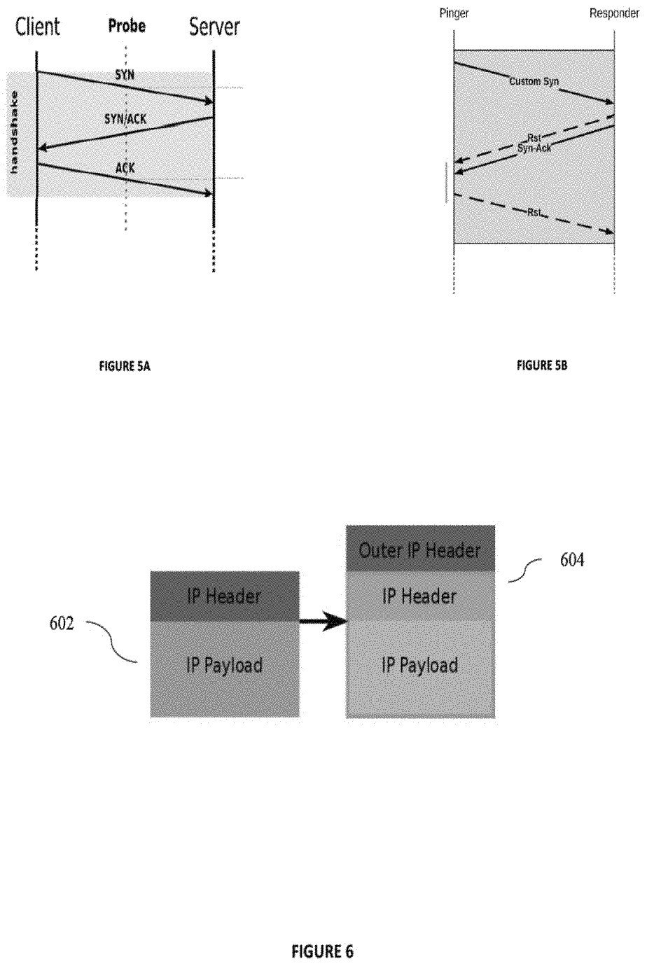

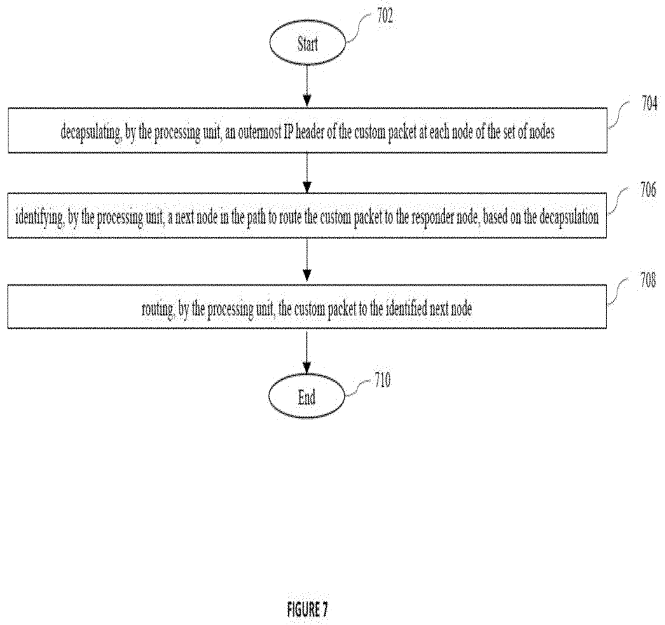

Referring back to FIG. 4, next step 408 includes encapsulating, by the packet generator [304], the custom packet for the path with one or more IP headers based on the set of nodes. To encapsulate the custom packet, firstly, an IP address of each node in the set of nodes are identified. The IP addresses for each node may be identified from the memory [310]. Secondly, one or more IP headers are generated based on the IP address of each node in the set of nodes. FIG. 6 shows an exemplary custom packet before and after encapsulation. 602 shows a custom packet generated in step 406. This custom packet comprises an IP payload and an IP header. The IP payload of the custom packet includes the reverse IP-IP signature and the IP header includes information such as source, destination, time-to-live, etc. 604 shows an encapsulated custom packet, wherein the custom packet is encapsulated by an outer IP header.

For instance, referring to the above example, the following nodes and IP addresses for each path are identified and the following IP headers are generated:

| | | | | IP Headers for the |
|---|---|---|---|---|
| S. No. | Path | Nodes & IP Address | | custom packet |
| Path_1 | r1 r2 r4 r7 | r1 | 1.1.1.0 | — |
| | | r2 | 2.2.2.0 | H1 |
| | | r4 | 4.4.4.0 | H2 |
| | | r7 | 7.7.7.0 | H3 |
| Path_2 | r1 r6 r4 r7 | r1 | 1.1.1.0 | — |
| | | r6 | 6.6.6.0 | H4 |
| | | r4 | 4.4.4.0 | H5 |
| | | r7 | 7.7.7.0 | H6 |
| Path_3 | r1 r6 r5 r7 | r1 | 1.1.1.0 | — |
| | | r6 | 6.6.6.0 | H7 |
| | | r5 | 5.5.5.0 | H8 |
| | | r7 | 7.7.7.0 | H9 |
| Path_4 | r1 r3 r5 r7 | r1 | 1.1.1.0 | — |
| | | r3 | 3.3.3.0 | H10 |
| | | r5 | 5.5.5.0 | H11 |
| | | r7 | 7.7.7.0 | H12 |

In the above example, the encapsulated custom packet_1 generated for Path_1 may be in the following format:

| | | | |
|---|---|---|---|
| H1 | H2 | H3 | IP Payload |

Similarly, the encapsulated custom packet_2 generated for Path_2 may be in the following format:

| | | | |
|---|---|---|---|
| H4 | H5 | H6 | IP Payload |

Referring back to FIG. 4, next the method proceeds to step 410 wherein the method includes deterministically routing, by the processing unit [306], the encapsulated custom packet from the pinger node to the responder node via the path. In an event multiple paths are identified, the encapsulated custom packet generated for each path in the previous step, is deterministically routed through its respective path. For instance, in the above example, the encapsulated custom packet_1 is deterministically routed through Path_1, the encapsulated custom packet_2 is deterministically routed through Path_2, etc.

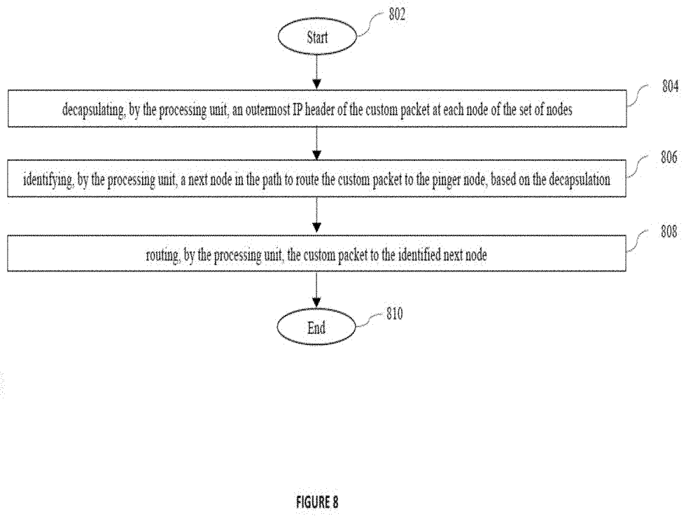

This deterministic routing of the custom packet is explained in more detail with reference to FIG. 7. Referring now to FIG. 7, wherein the method begins at step 702. The disclosure encompassed that the method begins when the encapsulated custom packet is generated.

At step 704, the method includes decapsulating, by the processing unit [306], an outermost IP header of the custom packet at each node of the set of nodes. For instance, consider the encapsulated packet_1 that is deterministically routed through Path_1. As shown above, the outermost IP header of the encapsulated packet_1 is H1 which includes the IP address of the node r2, i.e., 2.2.2.0. Thus, the packet is initially routed to r2. When the packet reaches node r2, the outermost header is decapsulated and the next header, i.e., H2 is identified. H2 includes the IP address of the destination node r4, i.e., 4.4.4.0.

Step 706 includes identifying, by the processing unit [306], a next node in the path to route the custom packet to the responder node, based on the decapsulation. Subsequently, at step 708, the custom packet is routed to the identified next node. In the above example, when the packet reaches node r2, the outermost header is decapsulated and the next header, i.e., H2 is identified. H2 includes the IP address of the destination node r4, i.e., 4.4.4.0. Thus, the next node to which the packet is to be routed is r4. The method then routes the packet to the identified next node, from r2 to r4.

Similarly, when the packet reaches node r4, the outermost header is decapsulated and the next header, i.e., H3 is identified. H3 includes the IP address of the destination node r7, i.e., 7.7.7.0. Thus, the next node to which the packet is to be routed is r7. The method then routes the packet to the identified next node, from r4 to r7.

The method of FIG. 7 then terminates at 710.

Referring back to FIG. 4, once the packet is deterministically routed from the pinger node to the responder node via the path, the method proceeds to step 412 wherein the method includes generating, by the packet generator, a reverse custom packet to be routed from the responder node to the pinger node via the path. This reverse custom packet to be routed from the responder node to the pinger node via the path is generated based on the embedded signature in the payload of the custom packet received at the responder node from the pinger node. As discussed above in reference to step 406, when a custom packet is generated, the signature of the path is embedded in the payload.

Next, step 414 includes encapsulating, by the packet generator [306], the reverse custom packet for the path with one or more IP headers based on the set of nodes. The reverse custom packet may be encapsulated based on the embedded signature in the payload of the custom packet received at the responder node. To encapsulate the reverse custom packet, firstly, an IP address of each node in the set of nodes/embedded signature is identified. The IP addresses for each node may be identified from the memory [310]. Secondly, one or more IP headers are generated based on the IP address of each node in the set of nodes.

For instance, referring to the above example, the following nodes and IP addresses for each path are identified and the following IP headers are generated:

| | | | | IP Headers for the |
|---|---|---|---|---|
| S. No. | Path | Nodes & IP Address | | custom packet |
| Path_5 | R7 r4 r2 r1 | r7 | 7.7.7.0 | — |
| | | r4 | 4.4.4.0 | H13 |
| | | r2 | 2.2.2.0 | H14 |
| | | r1 | 1.1.1.0 | H15 |
| Path_6 | R7 r4 r6 r1 | r7 | 7.7.7.0 | — |
| | | r4 | 4.4.4.0 | H16 |
| | | r6 | 6.6.6.0 | H17 |
| | | r1 | 1.1.1.0 | H18 |
| Path_7 | R7 r5 r6 r1 | r7 | 7.7.7.0 | — |
| | | r5 | 5.5.5.0 | H19 |
| | | r6 | 6.6.6.0 | H20 |
| | | r1 | 1.1.1.0 | H21 |
| Path_8 | R7 r5 r3 r1 | r7 | 7.7.7.0 | — |
| | | r5 | 5.5.5.0 | H22 |
| | | r3 | 3.3.3.0 | H23 |
| | | r1 | 1.1.1.0 | H24 |

In the above example, the encapsulated reverse custom packet_5 generated for Path_5 may be in the following format:

| | | | |
|---|---|---|---|
| H13 | H14 | H15 | IP Payload |

Similarly, the encapsulated custom packet_8 generated for Path_8 may be in the following format:

| | | | |
|---|---|---|---|
| H22 | H23 | H24 | IP Payload |

Referring back to FIG. 4, next the method proceeds to step 416 wherein the method includes deterministically routing, by the processing unit [306], the encapsulated reverse custom packet from the responder node to the pinger node via the path. In an event multiple paths are identified, the encapsulated reverse custom packet generated for each path in the previous step, is deterministically routed through its respective path. For instance, in the above example, the encapsulated reverse custom packet_5 is deterministically routed through Path_5, the encapsulated custom packet_8 is deterministically routed through Path_8, etc. In order to measure the correct round trip time, the present disclosure ensures that the reverse custom packet takes the same path in reverse as the custom packet took to reach the destination/responder node.

This deterministic routing of the reverse custom packet is explained in more detail with reference to FIG. 8. Referring now to FIG. 8, wherein the method begins at step 802. The disclosure encompasses that the method begins when the encapsulated reverse custom packet is generated.

At step 804, the method includes decapsulating, by the processing unit [306], an outermost IP header of the reverse custom packet at each node of the set of nodes. For instance, consider the encapsulated packet_5 that is deterministically routed through Path_5. As shown above, the outermost IP header of the encapsulated packet_5 is H13 which includes the IP address of the node r4, i.e., 4.4.4.0. Thus, the packet is initially routed to r4. When the packet reaches node r4, the outermost header is decapsulated and the next header, i.e., H14 is identified. H14 includes the IP address of the destination node r2, i.e., 2.2.2.0.

Step 806 includes identifying, by the processing unit [306], a next node in the path to route the reverse custom packet to the responder node, based on the decapsulation. Subsequently, at step 808, the reverse custom packet is routed to the identified next node. In the above example, when the packet reaches node r4, the outermost header is decapsulated and the next header, i.e., H14 is identified. H14 includes the IP address of the destination node r2, i.e., 2.2.2.0. Thus, the next node to which the packet is to be routed is r2. The method then routes the packet to the identified next node, from r4 to r2.

Similarly, when the packet reaches node r2, the outermost header is decapsulated and the next header, i.e., H15 is identified. H15 includes the IP address of the destination node r1, i.e., 1.1.1.0. Thus, the next node to which the packet is to be routed is r1. The method then routes the packet to the identified next node, from r2 to r1.

The method of FIG. 8 then terminates at 810.

Referring back to FIG. 4, once the reverse custom packet is deterministically routed from the responder node to the pinger node via the path, the method proceeds to step 418 wherein the method includes monitoring, by the monitoring unit [308], the latency between the pinger node and the responder node based at least on the deterministically routing of the encapsulated custom packet from the pinger node to the responder node via the path and deterministically routing the encapsulated reverse custom packet from the responder node to the pinger node via the path. When a packet is deterministically routed through a path from a pinger node to a responder node and back from the responder node to the pinger node, the total time taken by the packet to cover this is called the round trip time. The monitoring unit [308] calculates a round trip time for the path based on a time taken for deterministically routing of the encapsulated custom packet from the pinger node to the responder node via the path and deterministically routing the encapsulated reverse custom packet from the responder node to the pinger node via the path.

As is evident from the above example, by implementation of the proposed solution, only 4 probes are required to be run between the r1 and r7 nodes to monitor the latency between said nodes. As opposed to the existing solutions that require running thousands of probes to monitor latency between any two nodes, the present invention is very advantageous as it uses very less amount of resources as compared to the prior known solutions. Further, by routing packets deterministically between the nodes r1 and r7 via the four paths, the invention ensures that all the paths between the two nodes are tested. Furthermore, since latency for every path is determined using the present invention, it is much easier to identify the source of the latency/error in the network fabric, when compared to prior known solutions that were unable to identify such a source.

The method terminates at step 418. As discussed above, the method for monitoring latency is a continuous process. Thus, the termination step 418 only indicates termination of an instance implementation of the process. The monitoring process is not terminated but is instead restarted at 404.

The disclosure encompasses that the round trip time of a packet for each path, and for each pair of nodes in the network fabric, is calculated and maintained in the memory [310]. Any significant deviation in the round trip time for any path indicates an error or anomaly in said path.

This calculated round trip time of a packet may be compared to a historical round trip time for the path to identify or detect any anomalies in the path. For instance, if the historical data for round trip time of a packet is around 5 ms, but the round trip time calculated by the monitoring unit [308] at a particular instant of time is 8 ms, then it is identified that the latency on this path has increased.

The disclosure also encompasses identifying the exact source of the anomaly, i.e. identifying the communication links or nodes that are experiencing decreased efficiency, based on the roundtrip time of the paths stored in the memory [310]. For instance, consider again the following paths.

| S. No. | Path |
|---|---|
| Path_1 | r1 r2 r4 r7 |
| Path_2 | r1 r6 r4 r7 |
| Path_3 | r1 r6 r5 r7 |
| Path_4 | r1 r3 r5 r7 |

If only Path_1 is experiencing latency or increased round trip time, then it is likely that the anomaly lies in node r2.

As evident from the above disclosure, the present invention is advantageous and has significant technical advancement over known solutions. The present invention is capable of identifying the exact faulty devices very accurately instead of just pointing out a section of fabric that is degraded (as possible via the existing solutions). Further, the present invention can be used to plot latencies between each pair of devices for the whole data centre, which was not feasible using earlier solutions. In case of multiple Internet Service Provider (ISP) vendors, this solution can be used to draw a latency comparison between all ISP. Also, the results of the present invention can also be consumed by other systems to improve latencies or intelligently selecting the Exit Link for outbound traffic. Further, since the present invention provides an active latency monitoring system as opposed to a passive system in the prior art, the overall mean time to detect failures and mean time to resolve failures is much lesser as compared to the prior known solutions. As is well known increase in latency can potentially lead to application failures. Thus, by actively monitoring the latency in the network fabric with the implementation of the present invention, application failures can be avoided. In many cases, increased latency is often mistaken for network issues and thus goes unattended. By the implementation of the present invention, any increase in latency is monitored and alerts are generated prior to a failure.

1. A method for actively monitoring a latency in a network fabric comprising one or more data centers:
identifying, by an identification unit [302], a path between a pinger node and a responder node, wherein the pinger node and the responder node are located in the one or more data centers across the network fabric, and the path comprises a set of nodes;
generating, by a packet generator [304], a custom packet to be routed from the pinger node to the responder node via the path;
encapsulating, by the packet generator [304], the custom packet for the path with one or more IP headers based on the set of nodes;
deterministically routing, by a processing unit [306], the encapsulated custom packet from the pinger node to the responder node via the path;
generating, by the packet generator [304], a reverse custom packet to be routed from the responder node to the pinger node via the path;
encapsulating, by the packet generator [304], the reverse custom packet for the path with one or more IP headers based on the set of nodes;
deterministically routing, by the processing unit [306], the encapsulated reverse custom packet from the responder node to the pinger node via the path; and
monitoring, by a monitoring unit [308], the latency between the pinger node and the responder node based at least on the deterministically routing of the encapsulated custom packet from the pinger node to the responder node via the path and deterministically routing the encapsulated reverse custom packet from the responder node to the pinger node via the path.

2. The method as claimed in claim 1 wherein encapsulating, by the packet generator [304], the custom packet for the path with one or more IP headers based on the set of nodes comprises:
identifying, by the packet generator [304], an IP address of each node in the set of nodes; and
generating, by the packet generator [304], the one or more IP headers based on the IP address of each node in the set of nodes.

3. The method as claimed in claim 1 further comprises embedding, by the packet generator [304], a signature of the path in the custom packet to be routed from the pinger node to the responder node.

4. The method as claimed in claim 3 wherein the reverse custom packet to be routed from the responder node to the pinger node via the path is generated based on the embedded signature.

5. The method as claimed in claim 1 wherein deterministically routing, by the processing unit [306], the encapsulated custom packet from the pinger node to the responder node via the path comprises:
decapsulating, by the processing unit [306], an outermost IP header of the custom packet at each node of the set of nodes;
identifying, by the processing unit [306], a next node in the path to route the custom packet to the responder node, based on the decapsulation; and
routing, by the processing unit [306], the custom packet to the identified next node.

6. The method as claimed in claim 1 wherein deterministically routing, by the processing unit [306], the encapsulated reverse custom packet from the responder node to the pinger node via the path comprises:
decapsulating, by the processing unit [306], an outermost IP header of the custom packet at each node of the set of nodes;
identifying, by the processing unit [306], a next node in the path to route the custom packet to the pinger node, based on the decapsulation; and
routing, by the processing unit [306], the custom packet to the identified next node.

7. The method as claimed in claim 1 further comprising calculating, by the monitoring unit [308], a round trip time for the path based on a time taken for deterministically routing of the encapsulated custom packet from the pinger node to the responder node via the path and deterministically routing the encapsulated reverse custom packet from the responder node to the pinger node via the path.

8. The method as claimed in claim 7 further comprising detecting, by the monitoring unit [308], an anomaly in the path based on the calculated round trip time for the path and a historical round trip time data for the path.

9. The method as claimed in claim 1 wherein the latency is monitored for each pair of nodes within the network fabric.

10. A system for actively monitoring a latency in a network fabric comprising one or more data centers, the system comprising:
an identification unit [302] configured to identify a path between a pinger node and a responder node, wherein the pinger node and the responder node are located in the one or more data centers across the network fabric, and the path comprises a set of nodes;
a packet generator [304] connected to the identification unit [302], the packet generator [304] being configured to:
generate a custom packet to be routed from the pinger node to the responder node via the path, and
encapsulate the custom packet for the path with one or more IP headers based on the set of nodes;
a processing unit [306] connected to the identification unit [302] and the packet generator [304], wherein the processing unit [306] is configured to deterministically route the encapsulated custom packet from the pinger node to the responder node via the path, wherein the packet generator [304] is further configured to generate a reverse custom packet to be routed from the responder node to the pinger node via the path and encapsulate the reverse custom packet for the path with one or more IP headers based on the set of nodes, wherein the processing unit [306] is further configured to deterministically route the encapsulated reverse custom packet from the responder node to the pinger node via the path; and
a monitoring unit [308] connected to the packet generator [304] and the processing unit [306], the monitoring unit [308] being configured to monitor the latency between the pinger node and the responder node based at least on the deterministic routing of the encapsulated custom packet from the pinger node to the responder node via the path and deterministic routing the encapsulated reverse custom packet from the responder node to the pinger node via the path.

11. The system as claimed in claim 10 wherein the packet generator [304] is configured to encapsulate the custom packet for the path with one or more IP headers based on the set of nodes by:
identifying, by the packet generator [304], an IP address of each node in the set of nodes; and
generating, by the packet generator [304], the one or more IP headers based on the IP address of each node in the set of nodes.

12. The system as claimed in claim 10 wherein the packet generator [304] is further configured to embed a signature of the path in the custom packet to be routed from the pinger node to the responder node.

13. The system as claimed in claim 12 wherein the reverse custom packet to be routed from the responder node to the pinger node via the path is generated based on the embedded signature.

14. The system as claimed in claim 10 wherein the processing unit [306] is configured to deterministically route the encapsulated custom packet from the pinger node to the responder node via the path by:
decapsulating, by the processing unit [306], an outermost IP header of the custom packet at each node of the set of nodes;
identifying, by the processing unit [306], a next node in the path to route the custom packet to the responder node, based on the decapsulation; and
routing, by the processing unit [306], the custom packet to the identified next node.

15. The system as claimed in claim 10 wherein the processing unit [306] is configured to deterministically route the encapsulated reverse custom packet from the responder node to the pinger node via the path by:
decapsulating, by the processing unit [306], an outermost IP header of the custom packet at each node of the set of nodes;
identifying, by the processing unit [306], a next node in the path to route the custom packet to the pinger node, based on the decapsulation; and
routing, by the processing unit [306], the custom packet to the identified next node.

16. The system as claimed in claim 10 wherein the monitoring unit [308] is further configured to calculate a round trip time for the path based on a time taken for deterministically routing of the encapsulated custom packet from the pinger node to the responder node via the path and deterministically routing the encapsulated reverse custom packet from the responder node to the pinger node via the path.

17. The system as claimed in claim 16 wherein the monitoring unit [308] is further configured to detect an anomaly in the path based on the calculated round trip time for the path and a historical round trip time data for the path.

18. The system as claimed in claim 10 wherein the latency is monitored for each pair of nodes within the network fabric.
